(19) United States
(12) Patent Application Publication
(10) Pub. No.: US 2002/0143680 A1
(43) Pub. Date: Oct. 3, 2002

(54) Financial planning method and computer system

(76) Inventors: Edmond J. Walters, Collegeville, PA (US); Jeffrey R. Schulte, Perkiomenville, PA (US); Charles T. Cronin III, Berwny, PA (US); David T.W. Lee, Lower Gwynedd, PA (US); Joseph P. Linaugh, Lansdale, PA (US)

Correspondence Address: COZEN AND O'CONNOR, 1900 MARKET STREET, PHILADELPHIA, PA, 19103, US

(21) Appl. No.: 09/795,219

(22) Filed: Feb. 27, 2001

(51) Int. Cl. G06F 17/60

(52) U.S. Cl. 705/36

(57) ABSTRACT

A computer system, program, and method for assisting financial professionals in determining appropriate financial products for clients. The system and method present a first set of questions to a client and receives a first set of answers, then the system presents subsequent sets of questions to the client which are customized based on the answers to the first and other previous sets of questions so that the client is not asked redundant, unnecessary, or inappropriate questions, and receives answers to the subsequent sets of questions, wherein the questions request (A) personal information comprising client and dependent names, ages, and marital status; (B) financial information on one or more of savings accounts, investment accounts, insurance policies, retirement accounts, stock options, trusts, history of gifts to family members, loans, charitable contributions, charitable trusts, property, businesses, and income sources; and (C) goal information comprising retirement age and income goals and estate related goals. Information regarding each financial product available for sale by the financial professional is stored along with a set of rules which can be applied to the answers to the questions. In this way, which if any of the available financial products are appropriate to the client's financial situation and goals is determined for the financial professional.

### BACKGROUND OF THE INVENTION

This invention relates to computer systems and computer-implemented methods for assisting financial professionals in marketing financial products.

Financial planning is a complex task which usually requires the assistance of professionals. Although there has been much research and development of training systems for financial professionals, there are many so new financial products coming on the market that it is hard for the financial professional to keep up to date with the appropriateness of each product for clients and prospective clients. Furthermore, there are many existing financial products being withdrawn from the market on a daily basis. There are a myriad of financial vehicles that one may chose from to fund various life “events” (e.g., the purchase of a home, or the payment of a child's college education, etc.), and perhaps just as many sources of “advice” about how one should go about doing so. One may elect to “research” the various product and service offerings to setup an appropriate plan or, as is more commonly the case, knowledgeable persons may be consulted for this purpose. Professional brokers and financial planners typically have access to much more financial information as well as a wide variety of product offerings, but such information is normally provided to the consumer verbally or in some other terse fashion that makes it very difficult for the consumer to ascertain the “value” of the information.

There have been attempts to ameliorate this situation through the use of various computer-implemented planning tools. Thus, for example, life insurance brokers have the capability of entering personal and insurance plan data into a software program, which is then used to generate a table reflecting, among other things, the “value” of a policy over the life of the customer. Similar attempts have been made to display or illustrate temporal data in the context of a customer's “lifetime,” but such techniques do not have interactive capabilities so that one or more information variables can be easily manipulated to change the plan results, and they do not display the temporal information in a easy-to-read and useful format. Moreover, there is no financial planning tool currently available that provides effective display of temporal data, or the storage and manipulation of financial product descriptions for use in conjunction with such data in order to facilitate creation of a viable financial plan.

While some prior systems attempt to provide specific advice to an individual investor regarding steps they can take to improve their chances of meeting their financial goals while taking into consideration the investor's personal tradeoffs among risk, savings, and retirement age, no prior system is designed to assist the financial professional in obtaining, organizing, and processing personal, financial, and goal information about a client or prospective client to assist the professional in determining the most appropriate and suitable financial product for the client.

### SUMMARY OF THE INVENTION

It is therefore an object of the present invention to provide a computerized method and apparatus to assist a financial professional in obtaining, organizing, and processing personal, financial, and goal information about a client or prospective client and thereby to assist the professional in determining the most appropriate and suitable financial product for the client.

A still further object of the invention is to provide a computer-implemented method of financial planning to be used by a financial professional and a client together in an interactive manner.

Another object of this invention is to provide a system for obtaining a client's financial goals and assisting a financial professional in developing an appropriate financial plan which is stored in a database for retrieval and review and automated re-evaluation based on current financial instrument pricing obtained via a computer network. When this technique is used, the holdings in a customer's plan are revalued based on current prices and compared to the expected results in the plan.

An important object of the invention therefore is the provision of computer tools that enable a customer to participate in substantially all aspects of the financial planning process from goal definition through financial product selection. Such participation may be a very high level (e.g., allowing a general description of one's financial goals and investment strategy) to a very detailed participation (e.g., where the customer fully defines each cost constituent in a particular event, and each down payment and installment of each individual holding).

It is another more general object of the invention to provide a point-of-sale software tool that may be used by professional financial planners, insurance salespeople, securities representatives, trust officers, and other financial professionals for providing investment and risk management guidance to customers.

These objects, and others which will become apparent from the following disclosure, are achieved by the present invention which comprises in one aspect a computer system for assisting financial professionals in determining appropriate financial products for clients comprising:

a computer readable memory storing a computer program executable by a processor comprising:

a client questionnaire module that presents a first set of questions to a client and receives a first set of answers, presents subsequent sets of questions to the client which are customized based on the answers to the first and other previous sets of questions so that the client is not asked redundant, unnecessary, or inappropriate questions, and receives answers to the subsequent sets of questions, wherein the questions request (A) personal information comprising client and dependent names, ages, and marital status; (B) financial information on one or more of savings accounts, investment accounts, insurance policies, retirement accounts, stock options, trusts, history of gifts to family members, loans, charitable contributions, charitable trusts, property, businesses, and income sources; and (C) goal information comprising retirement age and income goals and estate related goals;

a financial product module which stores information regarding each financial product available for sale by the financial professional, the financial products comprising one or more of insurance products, investment products, estate planning products, and business products;

an expert system module comprising a stored set of rules which can be applied to the answers to the first and subsequent sets of questions for determining which if any of the available financial products are appropriate to the client's financial situation and goals;

one or more illustration modules which calculate the financial results of executing the financial products appropriate to the client's financial situation and goals;

a financial professional interface module for generating a web page displaying the client's current personal and financial status and the suitability of one or more of the available financial products for the client's financial situation and goals; and

a client interface module for generating a web page displaying one or more of the client's current marketable securities values, income goals, estimated retirement income, estate tax projections, and proceeds to heirs.

In another aspect, the invention comprises computer implemented method for helping a financial professional determine appropriate financial planning, investment, savings, and estate planning strategies for a client comprising the steps of: storing information regarding each financial product available for sale by the financial professional, the financial products comprising one or more of insurance products, investment products, estate planning products, and business products; presenting a first set of questions to the client and receiving a first set of answers, presenting a series of subsequent questions which are customized based on the answers received to the first and previous questions so the client is not asked redundant, unnecessary, or inappropriate questions, the questions requesting personal information comprising client and dependent names, ages, and marital status; financial information on one or more of savings accounts, investment accounts, insurance policies, retirement accounts, stock options, trusts, history of gifts to family members, loans, charitable contributions, charitable trusts, property, businesses, and income sources; and goal information comprising retirement age and income goals and estate related goals; applying stored rules for determining which if any of the financial products available for sale are appropriate to the client's financial situation and goals; delivering one or more web pages to the financial professional which identifies and ranks the available financial products according to appropriateness for the client; and delivering one or more web pages to the client displaying one or more of the client's current marketable securities values, income goals, estimated retirement income, estate tax projections, and net proceeds to heirs.

Preferably, the software uses a unique graphical user interface (GUI) that consolidates large quantities of customer information, product information, financial assumptions and knowledge of the financial markets into icons, representations, metaphors, gauges, active interface devices and other symbolic representations. The unique interface facilitates the use of progressive disclosure and selective input, allowing the broker and/or the customer to go to deeper levels of detail as may be desired, thereby providing effective management and delivery of a large amount of available data.

In some embodiments an outside information module obtains current financial information over a client-server system such as the Internet from banks, insurance companies, brokers, stock quotation sources, and interest rate quotation sources and uses the outside information to update the client's financial data. An outside or internal insurance policy illustration module can be provided to generate illustrations of insurance products.

The insurance products can comprise survivorship policies, long term care policies, universal life policies, variable life policies, first to die policies, annuities, irrevocable life insurance trusts, disability policies, and term policies, for example. The estate planning products can comprise spousal trusts, foreign trusts, estate tax insurance, and stock option exercises, and gifting at planned intervals, for example. The business products can comprise sale and leaseback of property, for example, The investment products can comprise mutual funds, bond funds, foreign stock funds, and the like.

Prior to this invention, financial planners and other experts in financial planning, estate planning, insurance, and investments would be consulted by the financial professional, but according to this invention the combined knowledge of a select group of such experts is used in deriving the rules which drive the expert system. In this way, the financial professional has automatic access to all of the client's relevant personal and financial information and goals, and the combined expertise of specialists and generalists is automatically applied to recommend to the financial professional, sometimes called a “producer” in this art, specific financial products out of an available array. The available array can be those which are preferred by the company or institution for which the producer works, or can be those which an self-employed broker is authorized to sell.

The system can comprise a report generator module or subsystem which creates printed financial plans for the client and the financial professional which include graphs demonstrating progress toward meeting the client's goals based on updated financial data and projections.

The goal information typically comprises a tolerance to investment risk and time during which assets are expected to remain invested, and the expert system module determines a hypothetical rate of return as a function of historical rates of return.

The data in the system can include a rate of inflation, rate of interest, variable insurance rates, and historical investment returns rates, and these values are applied for determining which if any financial products are appropriate for achieving the client's goals.

### BRIEF DESCRIPTION OF THE DRAWINGS

The figures depict a preferred embodiment of the present invention for purposes of illustration only. One skilled in the art will readily recognize from the following discussion that alternative embodiments of the structures and methods illustrated herein may be employed without departing from the principles of the invention described herein. For a more complete understanding of the present invention and the advantages thereof, reference should be made to the following Detailed Description taken in connection with the accompanying drawings in which:

FIG. 1 is a block diagram illustrating the modules within a financial system of the invention.

FIG. 2 is a schematic illustrating client and server computers, databases, processors, routers, and the Internet.

FIG. 3 is a block diagram illustrating client information gathering and updating.

FIG. 4 is a block diagram illustrating the input and output of the financial system.

FIG. 5 is a block diagram illustrating a method of receiving client information and passing it to the recommendations module.

FIG. 6 is a block diagram illustrating various categories of client information which are received and processed by the system of the invention.

FIG. 7 is a block diagram illustrating various categories of outside financial information received and processed by the system.

FIG. 8 is a block diagram illustrating the various types of financial products which are received in the system of the invention and which may be recommended by the system where appropriate.

FIG. 9 is a block diagram of the overall method carried out by the invention.

FIG. 10 is an illustration of a web page showing a stock option client input screen.

FIG. 11 is an illustration of a screen showing a client prioritization input.

FIG. 12 is an illustration of a screen showing retirement results calculated by the system based on both client information and current outside financial information.

FIG. 13 is an illustration of an insurance product designed to pay estate taxes.

### DETAILED DESCRIPTION OF THE DRAWINGS AND THE PREFERRED EMBODIMENTS

The figures depict a preferred embodiment of the present invention for purposes of illustration only. One skilled in the art will readily recognize from the following discussion that alternative embodiments of the structures and methods illustrated herein may be employed without departing from the principles of the invention described herein.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The steps of the present invention may be embodied in machine-executable instructions. The instructions can be used to cause a general-purpose or special-purpose processor that is programmed with the instructions to perform the steps of the present invention. Alternatively, the steps of the present invention may be performed by specific hardware components that contain hardwired logic for performing the steps, or by any combination of programmed computer components and custom hardware components.

While many embodiments of the invention are possible, for convenience one embodiment is illustrated in the drawings.

Referring first to FIG. 2, a web server computer 7 which comprises a processor and memory is connected to the Internet 10 through a router 6. The web server 7 is programmed with software which operates the computer to carry out the method of the invention or has access to remote memory such as a database server 9, which stores databases containing client accounts and information pertaining to financial products, for example. An application server 8 may also be provided. Financial professional computer 13 can communicate with the system through an Internet 10 using a browser, or a computer 12 communicating directly with the application server 8. Client computer 11 can communicate with the system through the Internet 10.

Clients and prospective clients may access the system of the invention by using a URL associated with the financial professional or the professional's company or institution either on their own computer 11 or locally at the office of the financial professional 12 or 13. The professionals may also access the system using computers directly connected with the application server 8 or web server 7 or through the Internet 10 with computer 13. The operating systems, browsers, markup languages, communications systems, internet service providers, hardware, software, video controllers, interfaces, audio controllers, multimedia devices, processors, etc., used in the system and method of the invention are very well known and conventional.

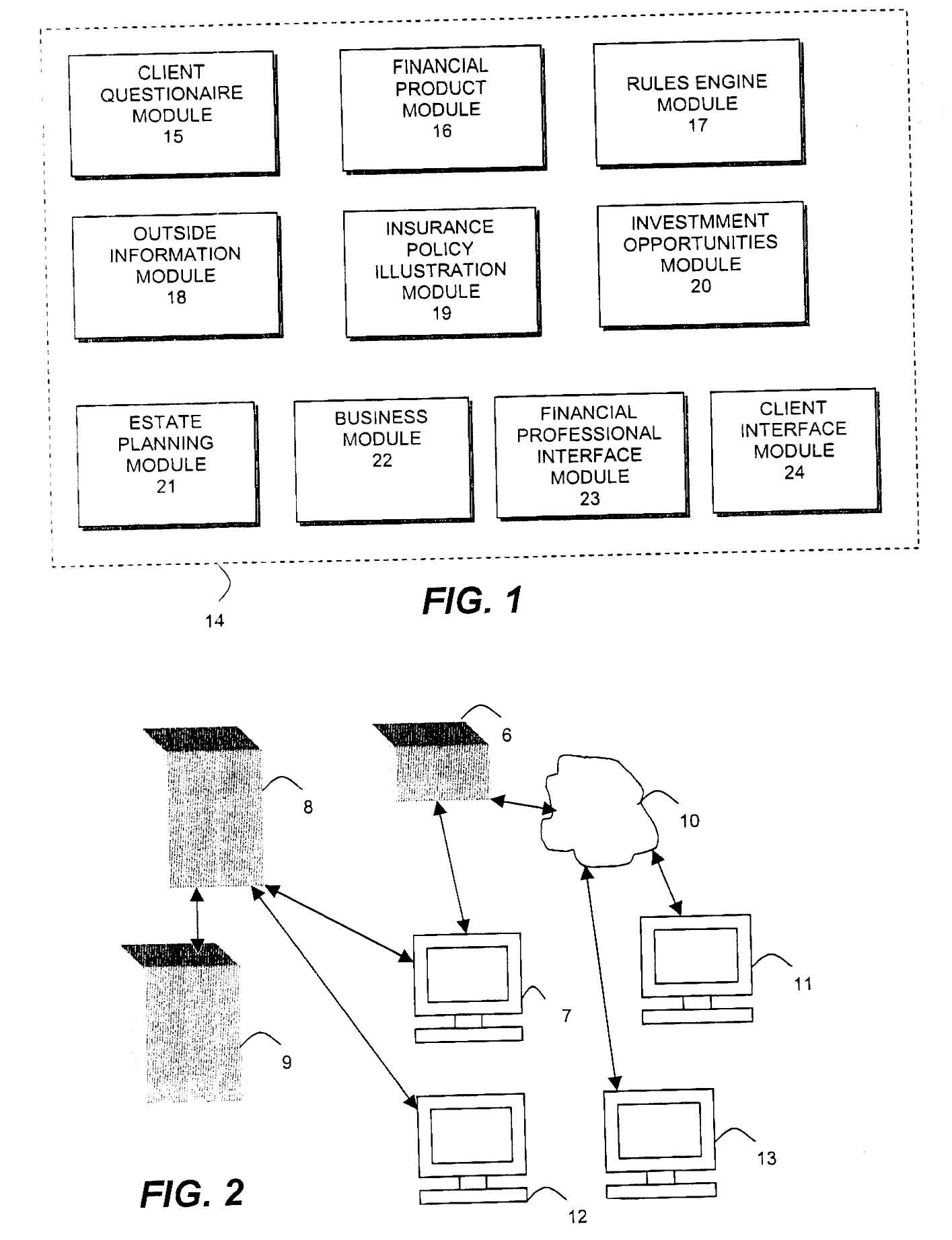

Referring now to FIG. 1, the system 14 of the preferred embodiment is programmed with several modules which will be described in more detail below: a client questionnaire module 15, a financial product module 16, an expert system module (rules engine) 17, an outside information module 18, an insurance policy illustration module 19, an investment opportunities module 20, an estate planning module 21, a business module 22, a financial professional interface module 23, and a client interface module 24.

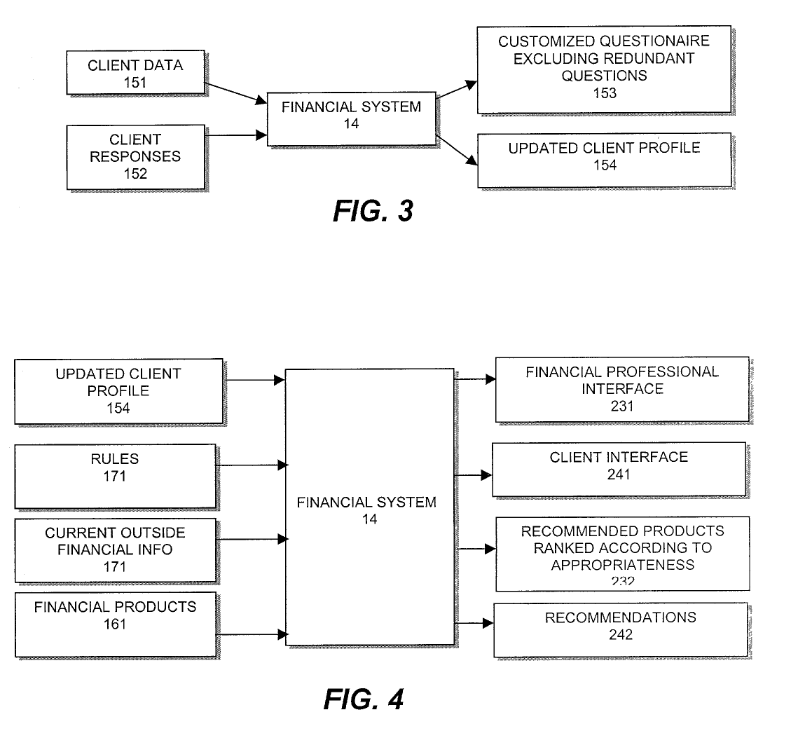

The client questionnaire module 15 is programmed to interact with the client computer at the web pages being viewed by the client. Module 15 is illustrated in more detail in FIG. 3 wherein client data 151 can be obtained from the financial professional of from accounts with a financial institution which owns the financial planning system, or from an information provider which has a relationship with that institution. An advantageous feature of this invention is that it customizes a client questionnaire 153 and presents it to the client for responses 152 and then upon receipt updates 154 the client profile.

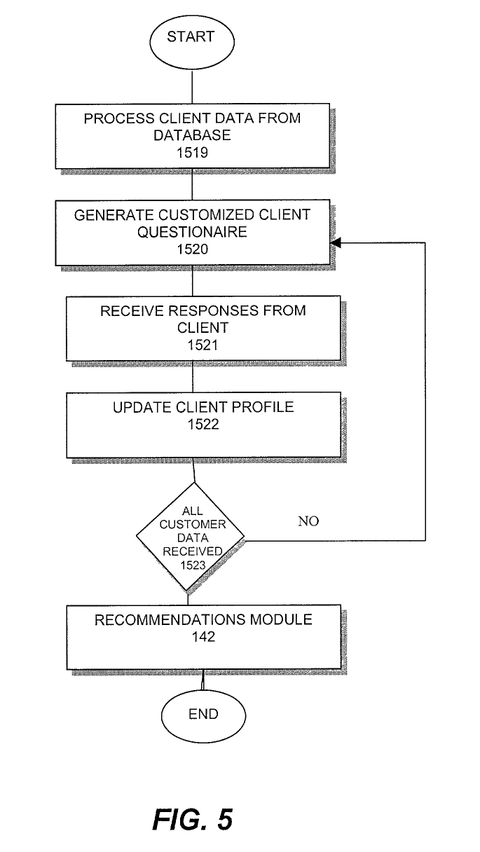

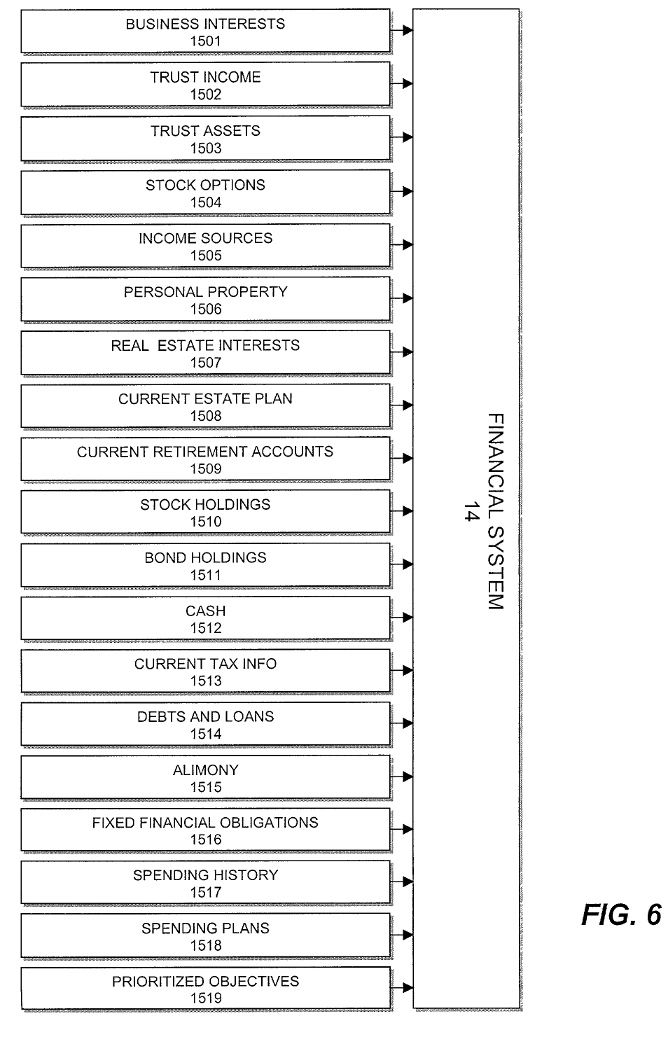

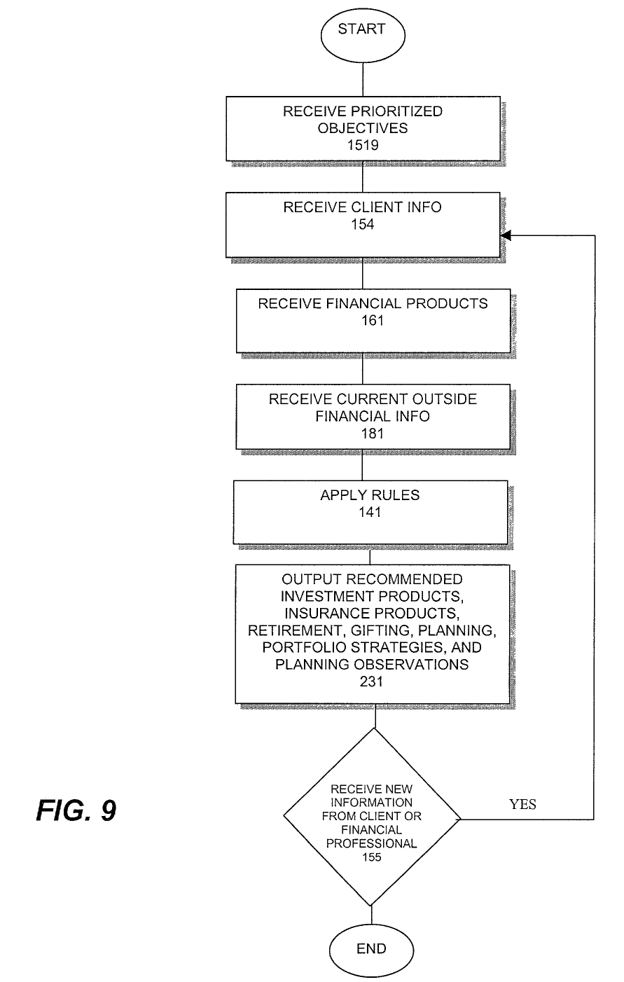

Referring to FIG. 5, the system processes client data from a database 1519 and generates 1520 a customized client questionnaire, receives 1521 responses from the client or, in some cases, from the financial professional who obtains the information from the client, e.g., in a personal interview, wherein the client profile is updated 1522 until all client data is received 1523, after which the recommendation module 142 processes the information as illustrated in more detail in FIG. 9, discussed below and may present financial products to the financial professional in a ranked order of appropriateness for the client's overall situation and priorities. The system presents a first set of questions to a client and receives a first set of answers, presents subsequent sets of questions to the client which are customized based on the answers to the first and other previous sets of questions so that the client is not asked redundant, unnecessary, or inappropriate questions, and receives answers to the subsequent sets of questions, wherein the questions request (A) personal information comprising names of the client's spouse, children, grandchildren, parents, and the like, ages, and marital status; (B) financial information on one or more of savings accounts, investment accounts, insurance policies, retirement accounts, stock options, trusts, history of gifts to family members, loans, charitable contributions, charitable trusts, and the like; and (C) goal information comprising one or more retirement goals, investment goals, gifting goals, savings rates, after death goals, and the like. As illustrated in FIG. 6, more detailed client information may include business interests 1501, trust income 1502, trust assets 1503, stock options 1504, income sources 1505, personal property 1506, real estate interests 1507, current estate plan 1508, current retirement accounts 1509, stock holdings 1510, bond holdings 1511, cash 1512, current tax info 1513, debts and loans 1514, alimony 1515, fixed financial obligations 1516, spending history spending plans 1518, and prioritized objectives 1519.

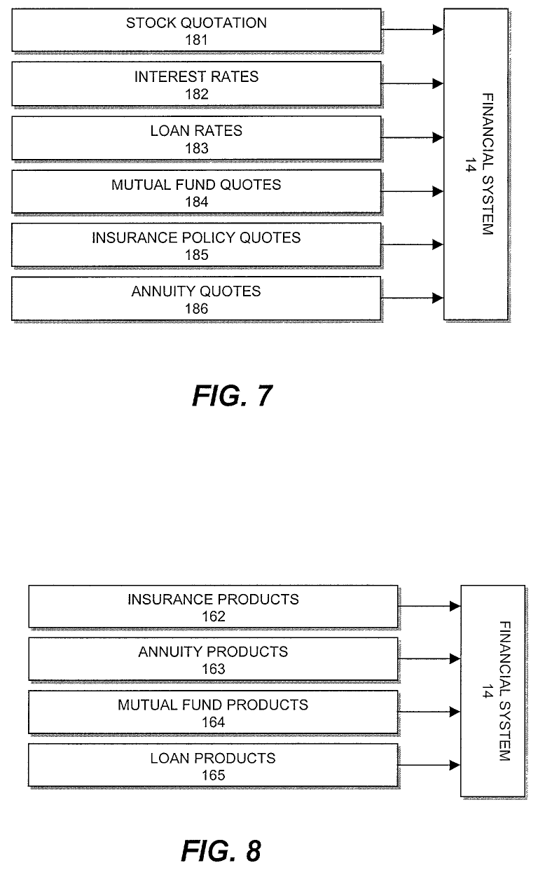

Financial product module 16 (FIG. 1) is programmed to store information regarding each financial product available for sale by the financial professional, the financial products as illustrated in FIG. 8 comprising one or more of insurance products 162, annuity products 163, mutual fund products 164, and loan products 165. This information is periodically updated when the products change, are added, or removed from those available to the professional, and can be automatically updated as illustrated in FIG. 7 with stock quotation 181, interest rates 182, loan rates 183, mutual fund quotes 184, insurance policy quotes 185, and annuity quotes 186.

Expert system (rules) module 17 (FIG. 1) is the rules engine which comprises a stored set of rules which can be applied to the answers to the first and subsequent sets of questions for determining which if any of the available financial products are appropriate to the client's financial situation and goals. As illustrated in FIG. 9, the prioritized objectives 1519, client information 154, financial products 161, and current outside financial information 181, are received, and rules module applies 141 rules which results in output 231 comprising recommended insurance products, investment product, retirement, gifting, planning, and portfolio strategies, and planning observations, preferably ranked in order of appropriateness. These results are observed on the client computer 11 and/or financial professional computer 13, and then selections are made or client information such as priorities or new holdings are updated 155, as appropriate, in which case the system is updated 154 and new output results are calculated by the rules engine 141.

Referring to FIG. 7, outside information module 18 obtains current financial information over the Internet from banks, insurance companies, brokers, stock quotation sources, and interest rate quotation sources and updates the client's financial data.

Insurance policy illustration module 19 (FIG. 1) generates illustrations of insurance products such as term, life, estate tax, and long term care policies.

Investment opportunities module 20 generates forecasts of results of use of one or more investment products for the client, and considers the effect and valuation of an client stock options.

Estate planning module 21 (FIG. 1) generates forecasts of the financial result of use of one or more estate planning tools such as gifting strategies, trusts, and the like.

Business module 22 generates tax and estate consequences for clients who own their own businesses.

Financial professional interface module 23 generates a web page displaying the client's current personal and financial status and the suitability of one or more of the available financial products for the client's financial situation and goals.

Client interface module 24 generates web pages displaying one or more of the client's current marketable securities values, income goals, estimated retirement income, estate tax projections, net proceeds to heirs, insurance policies, bank accounts, and the like.

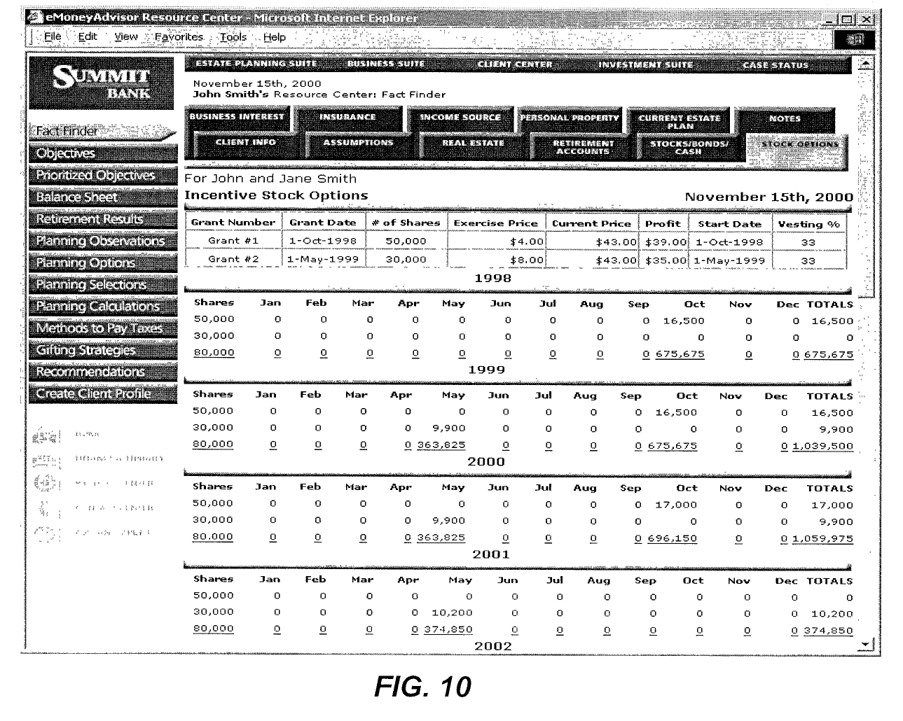

Referring now to FIG. 10, a client web page is illustrated which provides information on the client's stock options which are valued to market, and a series of tabs which can be selected to access other tools and modules of the system.

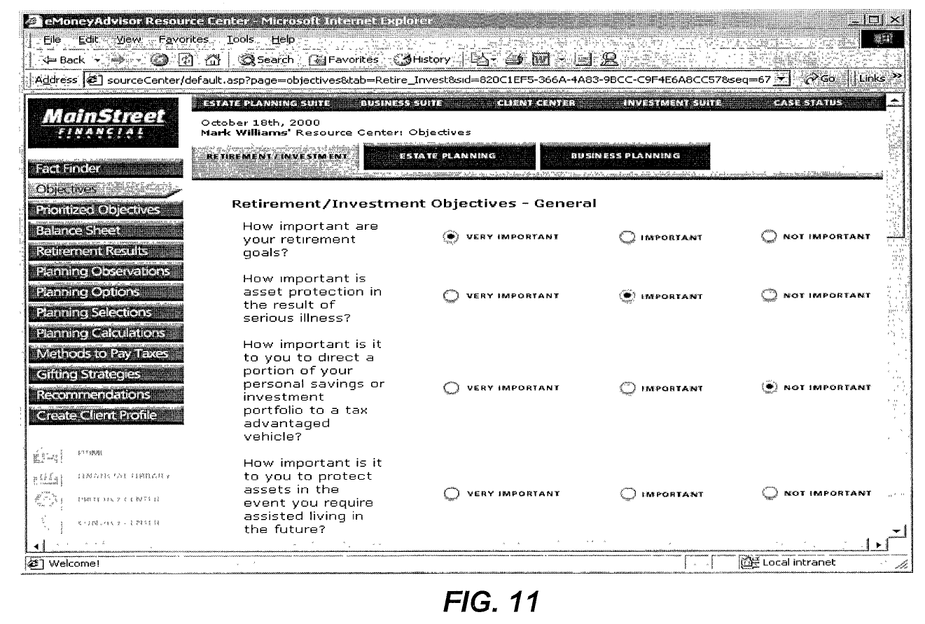

Referring now to FIG. 11, a web page is illustrated showing the prioritization of retirement and investment objectives.

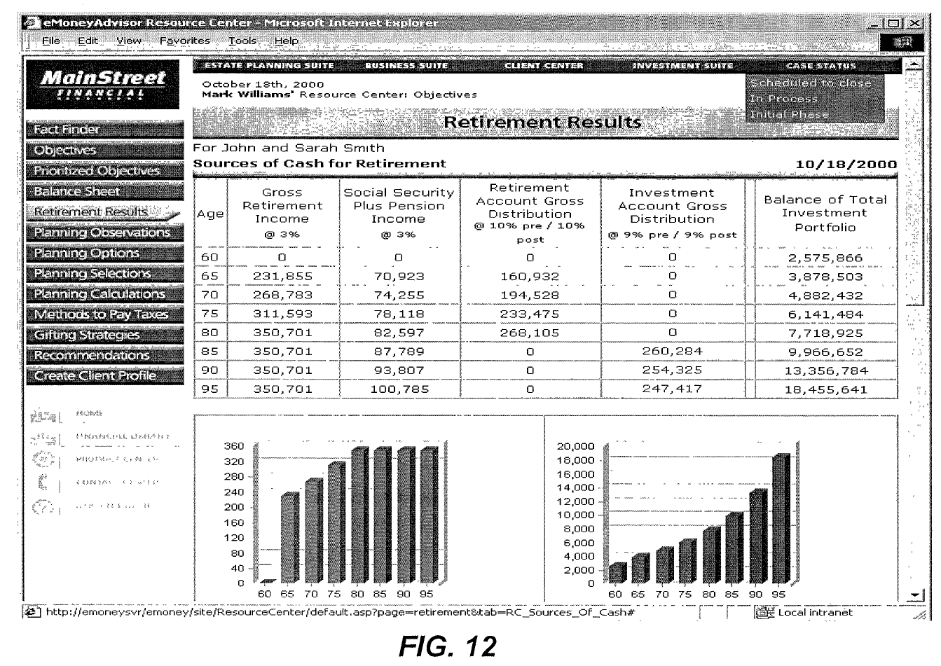

FIG. 12 illustrates a retirement results web page produced by the system which has processed all of the client and professional supplied data, outside data, and the rules to forecast retirement income and assets in a scenario which can be modified by the client or professional to change assumptions.

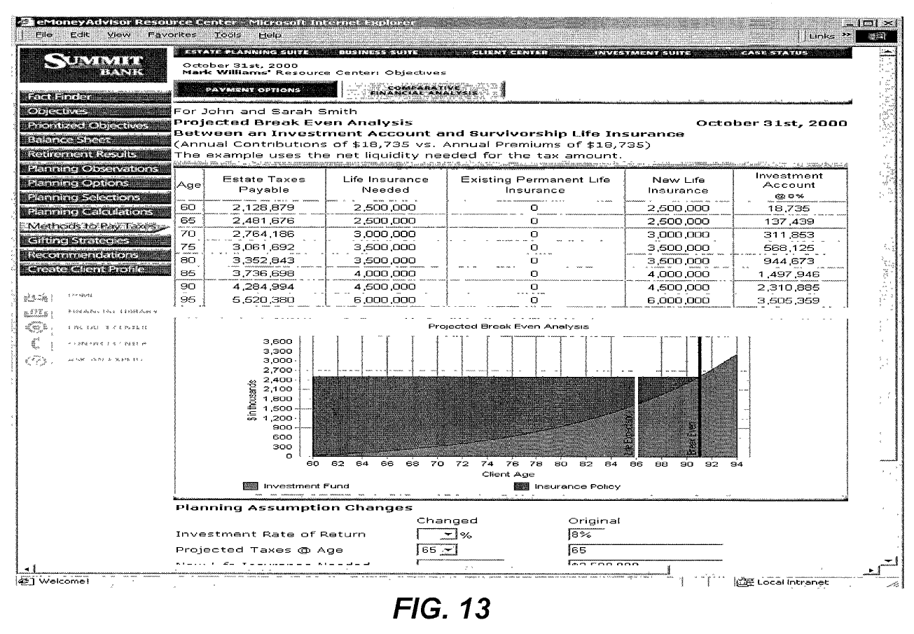

FIG. 13 illustrates a web page which includes a spreadsheet and graph which provide investment versus life insurance alternatives for the payment of estate taxes.

The foregoing discussion discloses and describes merely exemplary embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. A computer system for assisting financial professionals in determining appropriate financial products for clients comprising:
a computer readable memory storing a computer program executable by a processor comprising:
a client questionnaire module that presents a first set of questions to a client and receives a first set of answers, presents subsequent sets of questions to the client which are customized based on the answers to the first and other previous sets of questions so that the client is not asked redundant, unnecessary, or inappropriate questions, and receives answers to the subsequent sets of questions, wherein the questions request (A) personal information comprising client and dependent names, ages, and marital status; (B) financial information on one or more of savings accounts, investment accounts, insurance policies, retirement accounts, stock options, trusts, history of gifts to family members, loans, charitable contributions, charitable trusts, property, businesses, and income sources; and (C) goal information comprising retirement age and income goals and estate related goals;
a financial product module which stores information regarding each financial product available for sale by the financial professional, the financial products comprising one or more of insurance products, investment products, estate planning products, and business products;
an expert system module comprising a stored set of rules which can be applied to the answers to the first and subsequent sets of questions for determining which if any of the available financial products are appropriate to the client's financial situation and goals;
one or more illustration modules which calculate the financial results of executing the financial products appropriate to the client's financial situation and goals;
a financial professional interface module for generating a web page displaying the client's current personal and financial status and the suitability of one or more of the available financial products for the client's financial situation and goals; and
a client interface module for generating a web page displaying one or more of the client's current marketable securities values, income goals, estimated retirement income, estate tax projections, and net proceeds to heirs.

2. System according to claim 1 further including an outside information module which obtains current financial information over the Internet from banks, insurance companies, brokers, stock quotation sources, and interest rate quotation sources and updates the client's financial data.

3. System according to claim 1 further including an insurance policy illustration module for generating illustrations of insurance products.

4. System according to claim 1 wherein the insurance products comprise survivorship policies, long term care policies, universal life policies, variable life policies, first to die policies, annuities, irrevocable life insurance trusts, disability policies, and term policies; wherein the estate planning products comprise spousal trusts, and educational trusts; and wherein the investment products comprise mutual funds and retirement accounts.

5. System according to claim 1 wherein the rules are written based on the consensus of a plurality of certified financial planners and/or experts in fields comprising financial planning, estate planning, insurance, and investments.

5. System according to claim 1 further including a report generator module which outputs financial plans for the client and the financial professional, the plans including graphs demonstrating progress toward meeting the client's goals based on updated financial data and projections.

6. System according to claim 1 wherein the goal information comprises a tolerance to investment risk and time during which assets are expected to remain invested; and the expert system module determines a hypothetical rate of return as a function of historical rates of return.

6. System according to claim 1 wherein a rate of inflation, rate of interest, variable insurance rates, and historical investment returns rates are applied for determining which if any financial products are appropriate for achieving the client's goals.

7. A computer implemented method for assisting a financial professional in determining appropriate financial planning, investment, savings, and estate planning strategies for a client comprising the steps of:
storing information regarding each financial product available for sale by the financial professional, the financial products comprising one or more of insurance products, investment products, estate planning products, and business products;
presenting a first set of questions to the client and receiving a first set of answers, presenting a series of subsequent questions which are customized based on the answers received to the first and previous questions so the client is not asked redundant, unnecessary, or inappropriate questions, the questions requesting personal information comprising client and dependent names, ages, and marital status; financial information on one or more of savings accounts, investment accounts, insurance policies, retirement accounts, stock options, trusts, history of gifts to family members, loans, charitable contributions, charitable trusts, property, businesses, and income sources; and goal information comprising retirement age and income goals and estate related goals;
applying stored rules for determining which if any of the financial products available for sale are appropriate to the client's financial situation and goals;
delivering one or more web pages to the financial professional which identifies and ranks the available financial products according to appropriateness for the client; and
delivering one or more web pages to the client displaying one or more of the client's current marketable securities values, income goals, estimated retirement income, estate tax projections, and net proceeds to heirs.

8. Method of claim 7 further including the step of delivering at one or more of the client web pages a video clip illustrating the effect of utilizing one of the available financial products.

9. Method of claim 7 further including obtaining current financial information over the Internet regarding the client's bank accounts, insurance policies, brokerage accounts, current stock quotations, and interest rate quotation sources, and updating the client's financial data.

10. Method of claim 7 wherein the stored rules are based on the consensus of a plurality of certified financial planners and/or experts in financial planning, estate planning, insurance, and investments.
